(19) United States
(12) Patent Application Publication
(10) Pub. No.: US 2025/0153978 A1
(43) Pub. Date: May 15, 2025

(54) OVERHEAD CRANE MONITORING SYSTEM

(71) Applicant: NIPPON STEEL TEXENG. CO., LTD., Tokyo (JP)

(72) Inventors: Kiyokazu MOROOKA, Tokyo (JP); Hiroyuki MATSUMOTO, Tokyo (JP); Shingo SASAKI, Tokyo (JP); Ai INAZAWA, Tokyo (JP); Yuuya SAKAMOTO, Tokyo (JP)

(73) Assignee: NIPPON STEEL TEXENG. CO., LTD., Tokyo (JP)

(21) Appl. No.: 18/836,669

(22) PCT Filed: Feb. 6, 2023
(86) PCT No.: PCT/JP2023/003767

§ 371 Date: Aug. 7, 2024

(30) Foreign Application Priority Data
Apr. 4, 2022 (JP) 2022-062255

(51) Int. Cl. B66C 13/46; B66C 13/40; B66C 17/00; H04N 7/18; H04N 23/61

(52) U.S. Cl. CPC B66C 13/46; B66C 13/40; B66C 17/00; H04N 7/18; H04N 23/61

(57) ABSTRACT

An overhead crane monitoring system is for monitoring an overhead crane. The overhead crane includes a travelling body that travels along rails, a traverse trolley that travels in a direction perpendicular to a travelling direction of the travelling body along the travelling body, and a hoisting device mounted on the traverse trolley. The overhead crane monitoring system includes an imaging device (Camera) and a control device. The imaging device is installed on the travelling body. The imaging device is configured to change a recording direction and configured to zoom. The control device controls the imaging device to track and record a hoisting tool raised and lowered by the hoisting device based on an image recorded by the imaging device. This enables providing an operator with an image appropriate for identifying states of the hoisting tool or hoisted load of the overhead crane.

### TECHNICAL FIELD

The present invention relates to an overhead crane monitoring system.

### BACKGROUND ART

An overhead crane is installed for, for example, a material storage area. In order for the practical application of remote operation of the overhead crane, it is required to establish an overhead crane monitoring system that enables identifying states of the overhead crane. For example, it is important to accurately identify states of a hoisting tool and a hoisted load suspended by the hoisting tool.

Patent Literature 1 discloses a hoisted load monitoring device of a crane and a configuration in which the hoisted load monitoring device includes a hoisted load monitoring camera turnably disposed at a distal end of a top boom of a boom, and a driving amount of hoisted load monitoring camera driving means is controlled such that the hoisted load monitoring camera constantly tracks a hoisted load corresponding to a detected value of boom state detection means. The boom state detection means includes boom derricking angle detecting means and load detecting means.

Patent Literature 2 discloses a crane that includes a boom, and a configuration in which a photographic subject (for example, a hook or a luggage suspended on the hook) in an image recorded by a camera mounted on the boom is tracked, and a part including the photographic subject is cropped and displayed on a display device.

### CITATION LIST

### Patent Literature

Patent Literature 1: Japanese Laid-open Patent Publication No. 08-53290
Patent Literature 2: Japanese Laid-open Patent Publication No. 2019-156533

### SUMMARY OF INVENTION

### Technical Problem

Patent Literature 1 requires to install various sensors, such as boom derricking angle detecting means and load detecting means, which leads to a complicated configuration.

Patent Literature 2 has a configuration in which a part including a photographic subject is cropped from a recorded image, and therefore, it is possible that the image becomes rough.

Both Patent Literatures 1 and 2 target a boom-type crane mounted on a vehicle, and does not target a hoisting tool or hoisted load of an overhead crane.

The present invention has been made in consideration of the above-described circumstances, and it is an object of the present invention to provide an operator with an image appropriate for identifying states of a hoisting tool or hoisted load of an overhead crane.

### Solution to Problem

An overhead crane monitoring system of the present invention is for monitoring an overhead crane. The overhead crane includes a travelling body that travels along rails, a traverse trolley that travels in a direction perpendicular to a travelling direction of the travelling body along the travelling body, and a hoisting device mounted on the traverse trolley. The overhead crane monitoring system includes an imaging device and a control device. The imaging device is installed on the travelling body. The imaging device is configured to change a recording direction and configured to zoom. The control device controls the imaging device to track and record a hoisting tool raised and lowered by the hoisting device based on an image recorded by the imaging device.

### Advantageous Effects of Invention

The present invention enables providing an operator with an image appropriate for identifying states of a hoisting tool or hoisted load of an overhead crane.

### BRIEF DESCRIPTION OF DRAWINGS

FIG. 1 is a drawing illustrating a schematic configuration of an overhead crane.

FIG. 2 is a drawing illustrating the schematic configuration of the overhead crane.

FIG. 3A is a front view of a travelling body (a traverse trolley is omitted).

FIG. 3B is a plan view of the travelling body.

FIG. 4 is a drawing illustrating an exemplary functional configuration of a control device.

FIG. 5A is a drawing schematically illustrating an image recorded by a camera.

FIG. 5B is a drawing schematically illustrating the image recorded by the camera.

### DESCRIPTION OF EMBODIMENTS

The following describes a preferred embodiment of the present invention with reference to attached drawings.

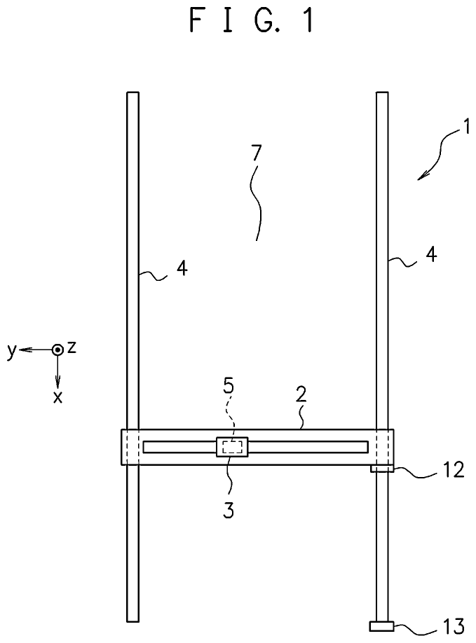

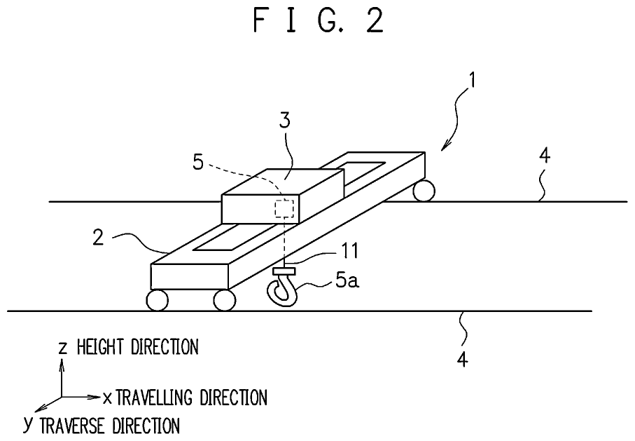

FIG. 1 and FIG. 2 illustrate a schematic configuration of an overhead crane 1. FIG. 1 is a plan view schematically illustrating the overhead crane 1, and FIG. 2 is a perspective view schematically illustrating the overhead crane 1.

The overhead crane 1 is installed for a storage area 7 inside a building, and conveys materials placed on the storage area 7 by suspending.

The overhead crane 1 includes a pair of rails 4 installed in the building, a travelling body 2 that travels along the rails 4, a traverse trolley 3 that travels along the travelling body 2, and a hoisting device 5 mounted on the traverse trolley 3. The traverse trolley 3 travels in a direction perpendicular to the travelling direction of the travelling body 2. The hoisting device 5 raises and lowers a hoisting tool 5a, such as a hook, via a wire 11 and suspends a hoisted load (material) placed on the storage area 7. In this application, the travelling direction (the extending direction of the rails 4) is defined as an x-direction, the traverse direction that is the travelling direction of the traverse trolley 3 is defined as a y-direction, and the height direction is defined as a z-direction.

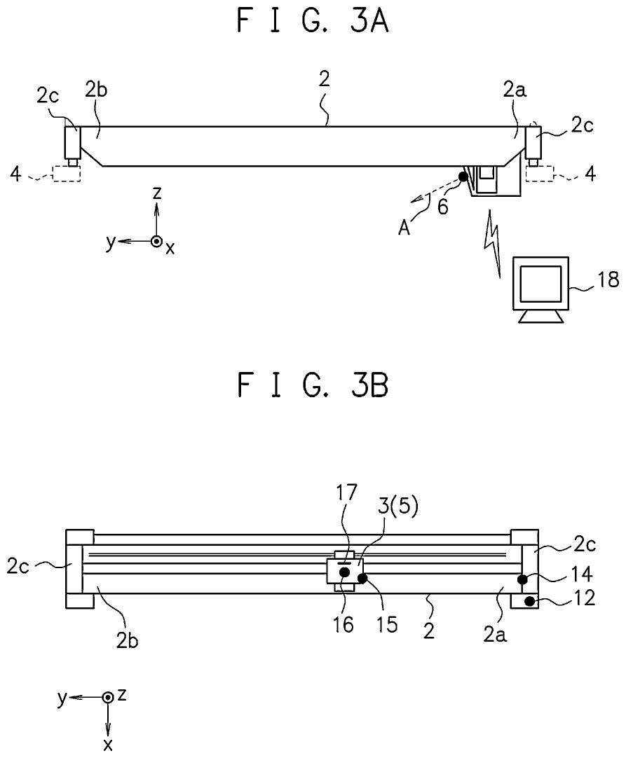

FIG. 3A and FIG. 3B illustrate an exemplary configuration of the travelling body 2. FIG. 3A is a front view of the travelling body 2 (the traverse trolley 3 is omitted), and FIG. 3B is a plan view of the travelling body 2.

The travelling body 2 is what is called a crane girder or the like, and is a long material extending in the y-direction, whose both ends have saddles 2c supported by the rails 4.

As illustrated in FIG. 3A, the travelling body 2 has one end portion 2a on which a digital camera (hereinafter abbreviated to a camera) 6 as an imaging device is installed at a lower portion. The camera 6 is a PTZ (Pan-Tilt-Zoom) camera configured to change a recording direction by pan/tilt and configured to zoom, which, while the detail will be described later, tracks and records the hoisting tool 5a raised and lowered by the hoisting device 5 under the control of a control device 100.

Note that, while a specific example is omitted, another camera used for identifying states of the overhead crane 1 may be installed on the travelling body 2, the traverse trolley 3, or on the ground, in addition to the camera 6.

As illustrated in FIG. 1 and FIG. 3B, a laser range finder 12 is installed on the travelling body 2, and a reflective plate 13 is installed in the proximity of an end portion of the rail 4 to face the laser range finder 12. These laser range finder 12 and reflective plate 13 enable measuring the travelling position of the travelling body 2. Information of the travelling position of the travelling body 2 measured by the laser range finder 12 and the reflective plate 13 is displayed on the display device installed in the remote operation room via, for example, a wireless communication. In this embodiment, the laser range finder 12 and the reflective plate 13 function as travelling position measuring means in the present invention. Note that it is allowed to configure the travelling position measuring means by using, for example, an IR cable, an IC tag, or the like, other than the laser range finder.

As illustrated in FIG. 3B, a laser range finder 14 is installed on the travelling body 2, and a reflective plate 15 is installed on the traverse trolley 3 to face the laser range finder 14. These laser range finder 14 and reflective plate 15 enable measuring the traverse position of the traverse trolley 3. Information of the traverse position of the traverse trolley 3 measured by the laser range finder 14 and the reflective plate 15 is displayed on the display device installed in the remote operation room via, for example, a wireless communication. In this embodiment, the laser range finder 14 and the reflective plate 15 function as traverse position measuring means in the present invention. Note that it is allowed to configure the traverse position measuring means by using, for example, an IR cable, an IC tag, or the like, other than the laser range finder.

As illustrated in FIG. 3B, the hoisting device 5 has a portion that relatively rotates when the hoisting tool 5a is raised or lowered, one side of which has a rotation detector 16 and the other side of which has a reflection mark 17. These rotation detector 16 and reflection mark 17 enables measuring a height position of the hoisting tool 5a by the hoisting device 5. Information of the height position of the hoisting tool 5a measured by the rotation detector 16 and the reflection mark 17 is displayed on the display device installed in the remote operation room via, for example, a wireless communication. In this embodiment, the rotation detector 16 and the reflection mark 17 function as height position measuring means in the present invention. Note that it is allowed to configure the height position measuring means by using, for example, a pulse generator or the like, other than the rotation detector.

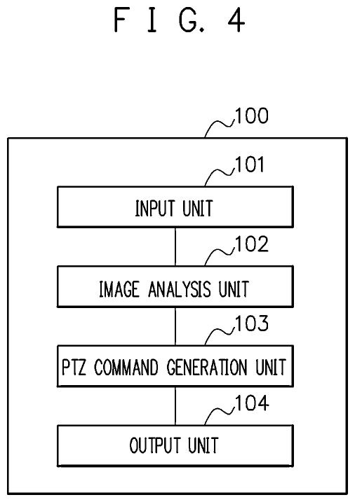

Here, FIG. 4 illustrates a functional configuration of the control device 100 that controls the camera 6.

The control device 100 controls the camera 6 to track and record the hoisting tool 5a raised and lowered by the hoisting device 5 based on the image recorded by the camera 6. In order to achieve this control, the control device 100 includes an input unit 101, an image analysis unit 102, a PTZ command generation unit 103, and an output unit 104. The control device 100 is configured of a computer device including, for example, a CPU, a memory, a storage, and the like, and the CPU executes predetermined programs to achieve the functions of the respective units 101 to 104.

The input unit 101 inputs data of the image recorded by the camera 6.

The image analysis unit 102 performs an image analysis on the image input by the input unit 101, and detects the position and the size of the hoisting tool 5a in the image.

The PTZ command generation unit 103 generates a PTZ command for tracking and recording the hoisting tool 5a so as to be captured with an approximately constant size at a predetermined position (for example, a position near the center) within a view angle of the image recorded by the camera 6 based on the position and the size of the hoisting tool 5a in the image detected by the image analysis unit 102.

The output unit 104 transmits the PTZ command generated by the PTZ command generation unit 103 to the camera 6. Upon receiving, the camera 6 tracks and records the hoisting tool 5a so as to be captured with the approximately constant size at the predetermined position (for example, the position near the center) within the view angle of the recorded image.

In the control device 100 thus configured, the respective units 101 to 104 repeatedly execute processes, thereby controlling the camera 6 to track and record the hoisting tool 5a raised and lowered by the hoisting device 5 based on the image recorded by the camera 6. Thus, the tracking and recording are performed by image analysis on the image recorded by the camera 6, and therefore, there is no necessity of installing various sensors, thereby allowing a simplified configuration.

The control device 100 may be installed, for example, in the remote operation room, or may be installed in an appropriate position of the overhead crane 1. In this case, the control device 100 and the camera 6 are configured to communicate in a wireless manner or a wired manner. It is also allowed that the camera 6 includes the respective units 101 to 104 such that the camera 6 itself functions as the control device 100.

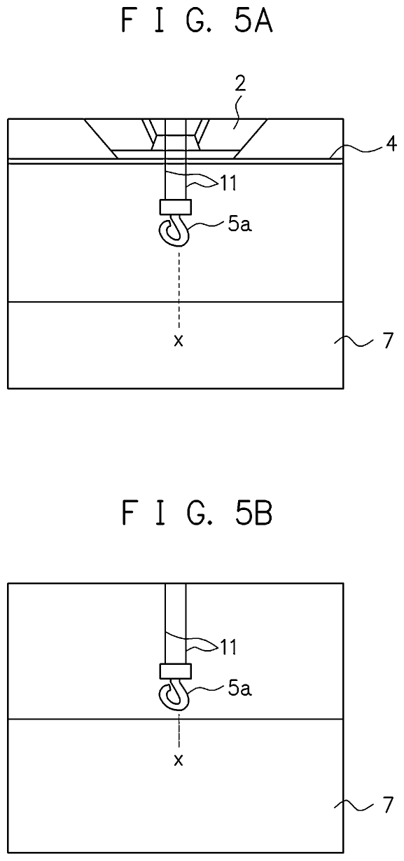

With reference to FIG. 5A and FIG. 5B, the image recorded by the camera 6 that tracks and records the hoisting tool 5a will be described. FIG. 5A and FIG. 5B are drawings schematically illustrating the image recorded by the camera 6.

FIG. 5A illustrates an image when the traverse trolley 3 is at a certain traverse position, and FIG. 5B illustrates an image when the hoisting tool 5a is lowered at the position in FIG. 5A. As illustrated in FIG. 5A and FIG. 5B, tracking and recording the hoisting tool 5a captures the hoisting tool 5a with the approximately constant size at the predetermined position (for example, the position near the center) within the view angle of the image recorded by the camera 6.

Here, irrespective of the height position of the actual hoisting tool 5a, the image recorded by the camera 6 is set to capture the region below the hoisting tool 5a in the storage area 7. That is, even when the actual hoisting tool 5a is at the highest position, it is set to capture the region below the hoisting tool 5a in the storage area 7. Accordingly, the hoisted load suspended by the hoisting tool 5a or the hoisted load placed on the storage area 7 as a work target of the hoisting tool 5a is captured in the image (in FIG. 5A and FIG. 5B, the hoisted load is omitted from illustration). Note that, in FIG. 5A and FIG. 5B, the dotted line below the hoisting tool 5a indicates the up/down direction of the hoisting tool 5a, and “x” indicates the position immediately below the hoisting tool 5a in the storage area 7. They are illustrated for convenience of explanation, and are not actually in the image.

Note that, while FIG. 5A and FIG. 5B illustrate the image when the traverse trolley 3 is in the certain traverse position, the hoisting tool 5a is captured with the approximately constant size at the predetermined position (for example, the position near the center) within the view angle of the image recorded by the camera 6 also when the traverse position changes, that is, when the traverse trolley 3 travels in a direction approaching the camera 6, and when it travels in a direction moving away.

As described above, the image recorded by the camera 6 is displayed on a display device 18 installed in the remote operation room via, for example, a wireless communication (see FIG. 3A). This allows identifying of the states of the hoisting tool 5a and the hoisted load of the overhead crane 1 in the remote operation room.

Note that, while it has been described that the image recorded by the camera 6 is displayed on the display device 18 installed in the remote operation room, the configuration is not limited to this. For example, the image recorded by the camera 6 may be displayed on a display device installed in an operator cabin on the overhead crane 1 (on the machine). The image recorded by the camera 6 may be displayed on a display device that can be observed by an operator who operates a controller (not illustrated), such as a pendant switch, on the work site.

The numerical value of the height position of the hoisting tool 5a measured by the rotation detector 16 and the reflection mark 17 may be displayed on the display device in a manner superimposed over the image recorded by the camera 6.

In the overhead crane monitoring system as configured above allows providing an operator with an image appropriate for identifying the states of the hoisting tool 5a and the hoisted load of the overhead crane 1, which eventually allows providing the operator with an image appropriate for remotely operating the overhead crane 1.

In detail, the camera 6 is installed on the travelling body 2, and therefore, an image that views the hoisting tool 5a in a manner overlooking it from obliquely above can be obtained. Tracking and recording the hoisting tool 5a captures the hoisting tool 5a with the approximately constant size at the predetermined position (for example, the position near the center) within the view angle of the image recorded by the camera 6. This allows the operator to visually perceive the hoisting tool 5a and the hoisted load as if he/she views the hoisting tool 5a and the hoisted load next to the hoisting tool 5a, thus allowing him/her to identify the situation. Specifically, the positional relationship between the hoisting tool 5a and the hoisted load can be visually perceived. It is also possible to confirm swinging of the hoisted load suspended by the hoisting tool 5a, and to confirm an accurate timing for dynamic lift off.

Here, when, for example, the camera 6 is installed on the traverse trolley 3, recording is made from near the area immediately above the hoisting tool 5a, and it is not easy to identify the relationship between the hoisting tool 5a or the hoisted load and the storage area in its image, which, for example, may make it difficult to confirm the accurate timing for dynamic lift off. When the camera 6 is fixed to the building, the operation range of Pan-Tilt-Zoom of the camera 6 is required to be increased for tracking and recording the hoisting tool 5a, which may make it difficult to smoothly track and record the hoisting tool 5a, and in some cases, make the image rough. In contrast, installing the camera 6 on the travelling body 2 as in the embodiment makes it easy to identify the relationship between the hoisting tool 5a or the hoisted load and the storage area, and also allows smooth tracking and recording less likely to have a rough image.

While the present invention has been described together with the embodiment above, the above embodiment merely illustrates concrete examples of implementing the present invention, and the technical scope of the present invention is not to be construed in a restrictive manner by the embodiment. That is, the present invention may be implemented in various forms without departing from the technical spirit or main features thereof.

While in the embodiment, there has been described the example where the overhead crane 1 is installed indoor (inside the building), the present invention is applicable to the case where the overhead crane 1 is installed outdoor.

1. An overhead crane monitoring system for monitoring an overhead crane, the overhead crane comprising:
a travelling body that travels along rails;
a traverse trolley that travels in a direction perpendicular to a travelling direction of the travelling body along the travelling body; and
a hoisting device mounted on the traverse trolley, wherein
the overhead crane monitoring system comprises:
an imaging device installed on the travelling body, the imaging device being configured to change a recording direction and configured to zoom; and
a control device that controls the imaging device to track and record a hoisting tool raised and lowered by the hoisting device based on an image recorded by the imaging device.

2. The overhead crane monitoring system according to claim 1, wherein
the control device detects a position and a size of the hoisting tool in the image recorded by the imaging device, and controls the imaging device to track and record the hoisting tool.

3. The overhead crane monitoring system according to claim 1, further comprising
a display device that displays the image recorded by the imaging device that tracks and records the hoisting tool.

4. The overhead crane monitoring system according to claim 1, wherein
the image recorded by the imaging device that tracks and records the hoisting tool captures a region below the hoisting tool in a storage area.

5. The overhead crane monitoring system according to claim 2, further comprising
a display device that displays the image recorded by the imaging device that tracks and records the hoisting tool.

6. The overhead crane monitoring system according to claim 2, wherein
the image recorded by the imaging device that tracks and records the hoisting tool captures a region below the hoisting tool in a storage area.
